(19) United States
(12) Patent Application Publication
(10) Pub. No.: US 2023/0020156 A1
(43) Pub. Date: Jan. 19, 2023

(54) DR. PIPE

(71) Applicant: Georg Fischer Rohrleitungssysteme AG, Schaffhausen (CH)

(72) Inventors: Tommy BECKMANN, Hilzingen (DE); Juergen STUMPP, Rafz (CH); Yannic BAEUCHLE, Beringen (CH); Philipp KLEINBRUCKNER, Ramsen (CH); Elmar HUFSCHMID, Albbruck-Birkingen (DE)

(21) Appl. No.: 17/863,671

(22) Filed: Jul. 13, 2022

(30) Foreign Application Priority Data
Jul. 14, 2021 (EP) 21 185 464.1

(51) Int. Cl. G01F 1/66; G01F 1/667; G01F 25/10; G01N 29/024; G01N 29/22

(52) U.S. Cl. CPC G01F 1/662; G01F 1/667; G01F 25/10; G01N 29/024; G01N 29/221; G01N 29/222; G01N 2291/02836; G01N 2291/105

(57) ABSTRACT

A method and device for configuring a clamp-on ultrasonic measuring device for flow measurement in pipelines, the clamp-on ultrasonic measuring device comprising at least two ultrasound transducers for flow measurement which face one another along the pipeline in a plane or diagonally. The autonomous acquisition and detection of the properties of the pipeline is carried out by means of a determined resistance value on the basis of the dimension of the pipeline and/or a circumferential measurement of the pipeline and/or a determined ultrasound value.

### CROSS-REFERENCE TO RELATED APPLICATIONS

This application claims the benefit and priority of European Patent Application No. 21 185 464.1 filed Jul. 14, 2021. The entire disclosure of the above application is incorporated herein by reference.

### BACKGROUND OF THE INVENTION

### Technical Field

The invention relates to a method for configuring a clamp-on ultrasonic measuring device and to a clamp-on ultrasonic measuring device for flow measurement in pipelines, the clamp-on ultrasonic measuring device comprising at least two ultrasound transducers for flow measurement which face one another along the pipeline in a plane or diagonally, comprising:
manual fitting of the ultrasonic measuring device on a pipeline external diameter,
autonomous detection and acquisition of the properties of the pipeline in relation to the ultrasonic measuring device,
establishment of parameters for accurate configuration of the ultrasonic measuring device with the aid of the detected properties of the pipeline,
optimization of the setting of the ultrasonic device on the basis of the parameters which have been determined.

### Discussion

Clamp-on flow meters may be used versatilely because of their simple mode of fastening on a pipeline, and the meter is used both in process and automation technology and also in supply and household technology. One great advantage of these meters is that they can carry out a flow measurement without contact with the medium and without damaging the pipe. Furthermore, a clamp-on flow meter may be used repeatedly and at different sites.

With previous clamp-on flow meters known from the prior art, the properties of the pipeline to which the clamp-on flow meter is adapted are manually set, or the corresponding parameters which are to be input according to the properties of the pipeline on the clamp-on flow meter. In general, these parameters may be taken from a table on the basis of the pipeline dimensions and the material.

As an alternative, it is also possible to read out the properties of the pipeline by scanning a barcode or QR code or by scanning script on the tube by means of text recognition, and then to input the parameters thereby determined into the meter, on the basis of which the ultrasonic testing may be carried out.

A disadvantage of the prior art is that the parameters need to be determined manually and input manually into the meter, so that errors may occur.

DE 10 2018 133 476 A1 discloses a method for setting up and/or testing an ultrasonic flow measurement site, the geometrical data of the pipeline being acquired by means of a camera and the optimal position of the meter being represented to the operating personnel by means of a display unit. A disadvantage in this case is that it requires a camera, that is to say equipment independent of the device, which may easily be forgotten or lost.

### SUMMARY OF THE INVENTION

It is an aspect of the invention to provide a method and a device which make it possible to autonomously detect the pipelines on which the device is fastened.

This aspect is achieved in that the autonomous acquisition and detection of the properties of the pipeline is carried out by means of a determined resistance value on the basis of the dimension of the pipeline and/or a circumferential measurement of the pipeline and/or a determined ultrasound value.

### DETAILED DESCRIPTION OF THE PREFERRED EMBODIMENTS

The method according to the preferred embodiment of the invention for configuring a clamp-on ultrasonic measuring device for flow measurement in pipelines includes:
manual fitting of the ultrasonic measuring device on a pipeline external diameter,
autonomous detection and acquisition of the properties of the pipeline in relation to the ultrasonic measuring device,
establishment of parameters for accurate configuration of the ultrasonic measuring device with the aid of the detected properties of the pipeline,
optimization of the setting of the ultrasonic device on the basis of the parameters which have been determined, the autonomous acquisition and detection of the properties of the pipeline being carried out by means of a determined resistance value on the basis of the dimension of the pipeline and/or a circumferential measurement of the pipeline and/or a determined ultrasound value.

The clamp-on ultrasonic measuring device according to the invention for flow measurement in pipelines comprises at least two ultrasound transducers for flow measurement which face one another along the pipeline in a plane or diagonally. The device according to the invention is fitted manually on the pipeline external diameter. Fine adjustment is not required for this, rather the device is mounted on the pipeline by clamping, clipping or strapping. The clamp-on ultrasonic measuring device then starts to detect the pipeline and acquires its properties. This means that the measurements of the pipeline, such as external and/or internal diameter and/or wall thickness, are preferably determined by the device according to the invention. On the basis of these properties, the associated parameters are established for accurate configuration and adjustment of the device according to the invention. Optimization of the setting of the ultrasonic device is then carried out on the pipeline on the basis of the parameters. This may be done manually by the operating personnel implementing the specifications which the device gives them in respect of the accurate position. It is, however, preferred for the device to be able to set itself, so as here again to have all the steps carried out autonomously as far as possible. Preferably, the ultrasonic device optimizes its setting continuously while it is arranged on the pipeline.

The autonomous acquisition and detection of the properties or geometrical data of the pipeline on which the device according to the invention is fastened is implemented by the acquisition and detection of an existing resistance on the basis of the dimension of the pipeline. That is to say, by means of a meter, preferably a potentiometer, which is preferably fitted on the external circumference, the diameter of the pipeline is acquired or imaged by the meter, whereupon a corresponding resistance is set in the meter, on the basis of which the dimension of the pipeline is detected. Each pipeline or each dimension of the pipeline therefore has its own resistance value, which is acquired and detected by means of the device according to the invention and on the basis of which the parameters can be determined. It is of course also possible to acquire the dimension of the internal diameter and/or of the wall thickness by means of a meter, on the basis of which a resistance in the meter is then set. The pipeline or wall thickness and/or internal diameter which is involved is detected on the basis of the resistance which has been determined, and the corresponding parameters are output in order to be able to carry out an ultrasonic measurement correctly, or so that the device according to the invention is or may be set optimally.

For the acquisition and detection of the pipeline, a simple circumferential measurement may also be carried out, which is preferably performed with a circumferential measuring tape. The simple circumferential extent of the pipeline is determined here, in which case this measurement may be carried out mechanically, optically or magnetically. This depends on the circumferential measuring tape which is used. It makes it possible to determine the external diameter of the pipeline, on the basis of which the parameters are in turn output.

As a further option for the acquisition and detection of the properties of the pipeline, an ultrasound value may be determined. This may be done by means of the ultrasound transducers already arranged on the device, or preferably by a further ultrasound transducer which is arranged on the device according to the invention. The ultrasound values determined make it possible to detect the pipeline, or its geometrical or material data, and to output the corresponding parameters in order to carry out the optimization on the device according to the invention.

It is advantageous for a potentiometer to be used in order to determine the resistance value on the basis of the dimension of the pipeline. To this end, a potentiometer is preferably arranged on the device according to the invention, preferably on the external diameter of the pipeline. The potentiometer is configured in such a way that it acquires and images the geometry of the pipeline, and specifically images it in such a way that a corresponding resistance is set on the potentiometer on the basis of the geometry of the pipeline, preferably the external diameter. This is preferably done by using elements which are displaced relative to one another on the basis of the dimension of the external diameter.

It is likewise conceivable for the circumferential measurement to be carried out by means of a circumferential measuring tape. The circumferential measuring tape may carry out the circumference detection mechanically, optically or magnetically.

As a further variant, it is possible to determine the pipeline properties or the geometry of the pipeline or material properties by means of an ultrasound value, the latter being determined by means of at least one ultrasound transducer. To this end, one of the ultrasound transducers already arranged on the device according to the invention may be used, or a further ultrasound transducer which is used exclusively to detect the pipeline or the wall thickness may also be arranged on the device. As already mentioned, there is preferably the possibility of the ultrasonic device optimizing its setting continuously while it is arranged on the pipeline. This may be done on the basis of constant signal detection of the ultrasound values and evaluation thereof, as well as on the basis of predetermined time intervals which specify a test of the ultrasound values, with the device thereby re-optimizing itself if required.

It is furthermore possible, on the basis of more or less continuous determination and acquisition of the ultrasound values, to draw conclusions relating to deposits, which may likewise lead to optimization of the device on the pipeline. This optimization is preferably also carried out autonomously by the device.

Preferably, it is directed perpendicularly to the external diameter of the pipeline.

It is advantageous for the geometrical data of the pipeline, preferably the external diameter, internal diameter and/or the wall thickness of the pipeline, to be acquired as properties of the pipeline. On the basis of these, it is possible to tell accurately which pipeline is involved. This means that the pipelines have different geometrical data with different materials and fields of use. PE pipes correspondingly have different standard measurements from PVC pipes or other plastic pipes as well as metal pipes or concrete pipes, so that from the acquired geometrical data it is possible to tell accurately which pipeline is involved and the corresponding parameters may be output for accurate positioning of the device according to the invention.

The method according to the preferred embodiment of the invention may also comprise a variety of the aforementioned acquisition and detection options and may combine them with one another. For example, the method may comprise acquisition and detection of the pipeline properties based on the determination of an ultrasound value and a resistance value of a meter, or a different combination as well as all variants in combination may be envisaged.

Preferably, in order to establish the parameters, the acquired properties, preferably geometrical data, are compared with the properties stored in a data memory and the parameters assigned to the properties are output to a control unit of the ultrasonic measuring device. By using these parameters, the device according to the invention may either adjust itself autonomously or is correspondingly set by operating personnel.

It has been found advantageous for the stored properties to be saved with the corresponding parameters on an external server and/or in a memory of the device according to the invention, data exchange taking place between the server and the memory of the device in order to update the properties and parameters. This ensures that the data are always in the most up-to-date state.

It has been found to be a preferred configuration for the optimization of the setting of the ultrasonic device on the basis of the parameters to be carried out autonomously and/or for the values for optimization of the setting of the ultrasonic device to be output to the user by means of a display device. In the case of autonomous setting of the device according to the invention, the advantage is that no human errors can take place during the accurate adjustment, although the device requires a drive for autonomous positioning of the ultrasound transducers.

Another aspect of the invention is furthermore to provide a device which makes it possible to autonomously detect the pipelines on which the device is fastened.

This aspect is also achieved according to the invention in that, for autonomous detection and acquisition of the properties of the pipeline, the clamp-on ultrasonic measuring device comprises a potentiometer, a circumferential measuring tape and/or at least one further ultrasound transducer.

The clamp-on ultrasonic measuring device for a pipeline according to the invention comprises a frame for arranging the clamp-on ultrasonic measuring device on a pipeline and for fastening further elements, at least two ultrasound transducers for flow measurement which face one another along the pipeline in a plane or diagonally, a control unit, a memory and a communication unit. For autonomous detection and acquisition of the properties, preferably of the geometry of the pipeline, the clamp-on ultrasonic measuring device comprises a potentiometer, a circumferential measuring tape and/or at least one further ultrasound transducer.

The ultrasonic measuring device according to the invention for flow measurements in pipelines makes the method according to the preferred embodiment of the invention for configuring the device according to the invention possible. This may, as already mentioned, be done by means of a potentiometer, a circumferential measuring tape and/or a further ultrasound transducer, which acquire the geometry of the pipeline and thereby establish the parameters.

Preferably, the ultrasonic measuring device according to the invention comprises a drive for adjusting the ultrasound transducers. This makes autonomous setting of the device possible.

Preferably, the circumferential measuring tape is arranged on the frame and is also used for fastening on the pipeline.

All configuration possibilities may be freely combined with one another, and the features mentioned in the method may also be applied to the device, and vice versa.

What is claimed is:

1. A method for configuring a clamp-on ultrasonic measuring device for flow measurement in pipelines, the clamp-on ultrasonic measuring device comprising at least two ultrasound transducers for flow measurement which face one another along the pipeline in a plane or diagonally, comprising:
manual fitting of the ultrasonic measuring device on a pipeline external diameter,
autonomous detection and acquisition of the properties of the pipeline in relation to the ultrasonic measuring device,
establishment of parameters for accurate configuration of the ultrasonic measuring device with the aid of the detected properties of the pipeline,
optimization of the setting of the ultrasonic device on the basis of the parameters which have been determined,
wherein the autonomous acquisition and detection of the properties of the pipeline is carried out by means of a determined resistance value on the basis of the dimension of the pipeline and/or a circumferential measurement of the pipeline and/or a determined ultrasound value.

2. A method according to claim 1, wherein a potentiometer is used in order to determine the resistance value on the basis of the dimension of the pipeline.

3. A method according to claim 1, wherein the circumferential measurement is carried out by means of a circumferential measuring tape.

4. A method according to claim 1, wherein at least one ultrasound transducer is used in order to determine the ultrasound value.

5. A method according to claim 1, wherein the autonomous detection and acquisition of the properties acquires the geometrical data of the pipeline, preferably the external diameter, internal diameter and/or the wall thickness of the pipeline, an additional ultrasound transducer preferably being used for this in addition to the ultrasound transducers already present.

6. A method according to claim 1, wherein in order to establish the parameters, the acquired properties are compared with the properties stored in a data memory and the parameters assigned to the properties are output to a control unit of the ultrasonic measuring device.

7. A method according to claim 1, wherein the stored properties are saved with the corresponding parameters on an external server and/or in a memory of the ultrasonic device, data exchange taking place between the server and the memory of the ultrasonic device in order to update the properties and parameters.

8. A method according to claim 1, wherein the optimization of the setting of the ultrasonic device is carried out autonomously and/or the values for optimization of the setting of the ultrasonic device are output to the user by means of a display device.

9. A clamp-on ultrasonic measuring device for carrying out the method according to claim 1 for a pipeline, comprising a frame for arranging the clamp-on ultrasonic measuring device on the pipeline and for fastening further elements, at least two ultrasound transducers for flow measurement which face one another along the pipeline in a plane or diagonally, a control unit, a memory and a communication unit, wherein, for autonomous detection and acquisition of the properties of the pipeline, the clamp-on ultrasonic measuring device comprises a potentiometer, a circumferential measuring tape and/or at least one further ultrasound transducer.

10. A clamp-on ultrasonic measuring device according to claim 9, wherein the ultrasonic device comprises a drive for adjusting the ultrasound transducers.

11. A clamp-on ultrasonic measuring device according to claim 9, wherein the circumferential measuring tape is arranged on the frame and is also used for fastening on the pipeline.
